(19) United States
(12) Patent Application Publication
(10) Pub. No.: US 2006/0203991 A1
(43) Pub. Date: Sep. 14, 2006

(54) System for managing employee performance in a complex environment

(75) Inventors: Daniel Kramer, Suwanee, GA (US); Patrick Scott Beasley, Atlanta, GA (US); David Frederick Nti-Berko, Acworth, GA (US)

Correspondence Address: GARDNER GROFF SANTOS & GREENWALD, P.C., 2018 POWERS FERRY ROAD, SUITE 800, ATLANTA, GA, 30339, US

(73) Assignee: Cingular Wireless, LLC

(21) Appl. No.: 11/200,840

(22) Filed: Aug. 10, 2005

Related U.S. Application Data
(60) Provisional application No. 60/665,398, filed on Mar. 25, 2005.
(60) Provisional application No. 60/659,648, filed on Mar. 8, 2005.

(51) Int. Cl. H04M 3/00

(52) U.S. Cl. 379/265.06

(57) ABSTRACT

Employee performance in a call center or similar complex work environment is managed by selecting a controlled number of performance criteria from among numerous possible performance criteria, establishing performance goals for the selected performance criteria, communicating the goals to the call center employees, monitoring the actual performance of the employees in relation to the performance goals, and reporting the performance of the employees in relation to the performance goals to the employees, management or both.

### CROSS-REFERENCE TO RELATED APPLICATIONS

The benefit of the filing dates of U.S. provisional patent application Ser. No. 60/659,648, filed Mar. 8, 2005, entitled CUSTOMER SERVICE SYSTEM, and U.S. provisional patent application Ser. No. 60/665,398, filed Mar. 25, 2005, entitled SYSTEM FOR MANAGING EMPLOYEE PERFORMANCE IN A COMPLEX ENVIRONMENT, is hereby claimed, and the specifications thereof are incorporated herein by this reference.

### FIELD OF THE INVENTION

The present invention relates generally to systems and techniques for managing employee performance and, more specifically, to a system and technique for managing employee performance in a complex work environment, such as managing employee performance in a call center.

### DESCRIPTION OF THE RELATED ART

In many business environments, managing employee performance is problematic. One source of problems is the rather complex nature of performances to be measured and managed. Oftentimes, performance of the worker can be measured in a myriad number of ways and often is. If one focuses solely on a single performance criterion alone, this can lead to unscrupulous individuals manipulating the outcome to mask other deficiencies. For example, in a manufacturing environment if one were to measure only the output of manufactured goods, individuals working in that environment will naturally adjust their performance to meet targets for manufacturing output. Unfortunately, quality may suffer, or other problems may creep in.

The problems are particularly acute for managers managing workers in a call center environment. In a typical call center, a great many workers are performing the same task of answering calls from customers with questions, concerns, technical problems, inquiries, etc. Modern management strategies for dealing with the complex performance of call center employees have identified dozens of performance criteria, and perhaps as many as one-hundred. However, it can be difficult to simultaneously track a great many performance criteria. Furthermore, the typical employee (human worker) has a difficult time trying to effectively respond to management demands to improve performance or maintain performance in so many different categories.

Therefore, it has been common in the call center industry to focus on typically only one performance criterion as a way of measuring the performance of the call center employees and monitoring the same. Unfortunately, this can lead to serious abuses. For example, suppose the call center manager wishes to monitor and improve the average length of time that callers are on the phone with the call center employees. The call center manager might set as a target that the average call should take, for example, seven minutes. If this is communicated to the employees, and the employees presently are averaging eight minutes, some employees will unfortunately determine that one way to lower their average call time would be to intentionally disconnect callers once in awhile. For those callers who get disconnected in this way, they receive very poor, unacceptable service from the call center. However, the individual employee's performance, as measured by an average call time, actually would be improved by having a few very short calls to average out the longer calls. As a further example of how such a simplistic view of the management problem could be abused by employees, if the goal is to have seven-minute average call times, a worker might determine that he or she could disconnect a first caller almost immediately and then place a second caller on hold for thirteen or fourteen minutes before transferring the second caller to someone else. If management looked only at average call time, this employee would seem to be an ideal performer by having two calls that took a total of fourteen minutes, for an average of seven minutes. However, the first caller was completely abused by having the phone call terminated, and the second caller was equally abused by being put on hold for no good reason.

Accordingly, it can be seen that a need remains in the art for a system and technique for managing the rather complex performance of employees, particularly the complex performance of call center employees. It is to the provision of such a system and technique that the present invention is primarily directed.

### SUMMARY OF THE INVENTION

The present invention relates to a system and method for managing human performance in a call center or similar complex work environment. In an exemplary embodiment, three to seven performance criteria are chosen from among numerous possible performance criteria, and performance goals for the three to seven performance criteria are established. The performance goals are communicated to the call center employees. The performance of the call center employees is monitored in relation to the performance goals, and the performance of the employees in relation to the performance goals is reported. In some embodiments of the invention, the performance can be reported to management alone, while in other embodiments it can be reported to both management and to the employees as may be needed to urge the workers toward the performance goals.

Preferably, the three to seven performance criteria optimally consist of three to six performance criteria, and most preferably consist of only four to six. Preferably, one of these performance criteria is the quantity of call transfers (which should be minimized). Preferably, another of these performance criteria is the quantity of short calls (which should be minimized or held at zero). Preferably, still another of these performance criteria is a measurement of the employee's availability to receive calls (which should be maximized). Preferably, yet another of these performance criteria is the average call handle time, i.e., the average length of time it takes to handle a phone call (which should be minimized).

Optionally, additional performance criteria can be employed. One such performance criterion can be the frequency of repeat calls (which should be minimized). The frequency of repeat calls is particularly useful in combination with one or more of the above-mentioned performance criteria because it can be considered a strong measure of employee effectiveness, whereas the above-mentioned four criteria can be considered measures of employee productivity. Another such effectiveness performance criterion can be a quality score that subjectively measures the quality with which an employee handles calls as judged by a supervisor or other person. Effectiveness and productivity are complementary measures in that it is difficult for an employee to increase one artificially without adversely impacting the other.

In using multiple performance criteria in this way, advantageously management can strike an effective and desirable balance between efficiency (or productivity) and effectiveness (or quality).

In a preferred form, the above-described technology is embodied in a computer-implemented method and system. The system receives input data from telephony equipment (commonly referred to as a “switch”), such as a private branch exchange (PBX), providing the basic performance criteria data. The system can comprise a database with pre-established queries (reports) to allow management to monitor and manage the performance of organizations. Preferably, the reports are accessible in real-time or near real-time at one or more computer terminals, personal computers, computer workstations, or similar devices. Also preferably, the reports allow management to view the performance of an organization against its target, to benchmark the performance of a call center against other like organizations, and to compare the organization against its past performance. Also preferably, the system is configured to allow management to look at performance across an entire organization, or within specific facilities, or even down to the team or individual level.

### BRIEF DESCRIPTION OF THE DRAWINGS

FIG. 1 is a diagrammatic illustration of a call center system in accordance with one embodiment of the invention.

FIG. 2 is a block diagram of the employee monitoring system portion of the call center system of FIG. 1.

FIG. 3 is a flow diagram illustrating an exemplary method for managing employee performance in the system of FIG. 1.

FIG. 4 depicts a first graphical user interface (GUI) screen of a software tool for effecting steps of the method illustrated in FIG. 3.

FIG. 5 depicts a second GUI screen of a software tool for effecting steps of the method illustrated in FIG. 3.

FIG. 6 depicts a third GUI screen of a software tool for effecting steps of the method illustrated in FIG. 3.

FIG. 7 depicts a fourth GUI screen of a software tool for effecting steps of the method illustrated in FIG. 3.

FIG. 8 depicts a fifth GUI screen of a software tool for effecting steps of the method illustrated in FIG. 3.

FIG. 9 depicts a sixth GUI screen of a software tool for effecting steps of the method illustrated in FIG. 3.

FIG. 10 depicts a seventh GUI screen of a software tool for effecting steps of the method illustrated in FIG. 3.

### DETAILED DESCRIPTION

In the following description, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention.

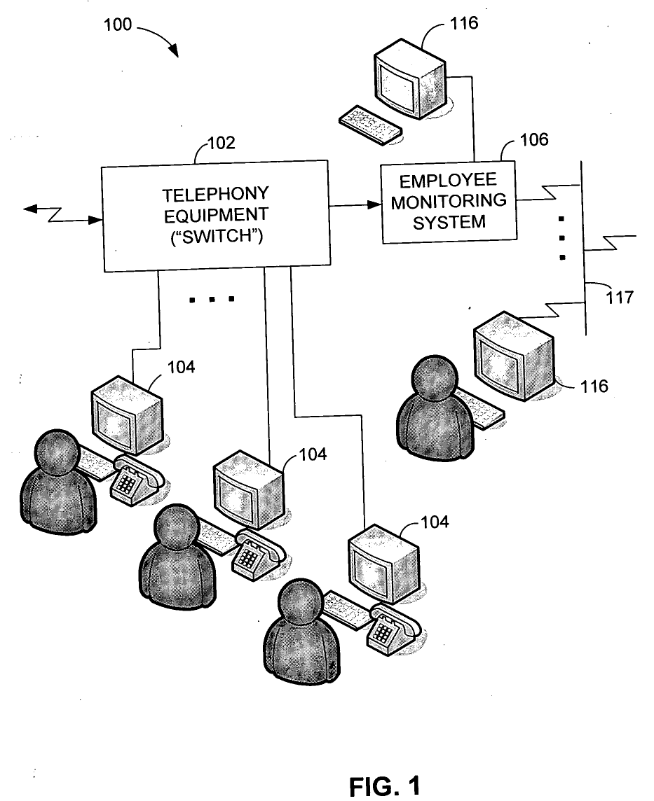

As illustrated in FIG. 1, a call center 100 associated with a company or other organization includes conventional call center telephony equipment 102 (commonly referred to in the art as a “switch”), and a number of associated telephone stations 104, each manned by an employee. Telephony equipment 102, which may comprise a private branch exchange (PBX) or similar switching circuitry and associated computerized controllers, is connected to the public telephone network. Telephony equipment 102 receives telephone calls from customers or others who deal with the company and routes the calls to telephone stations 104. The structures and operation of call center telephony equipment 102 and call center telephone stations 104 are well-known in the art and therefore not described in further detail herein (i.e., in this patent specification). Briefly stated, employees (sometimes referred to as “agents”) use telephone stations 104 to answer the calls and perform the tasks known in the art to be required of call center employees. For example, the employees may be tasked with ascertaining and answering the customers' questions and concerns, and providing assistance with solving customers' problems relating to the company's products or services. In addition or alternatively, call center employees may be tasked with selling products or services. Call center 100 may be located along with other portions of the company or may be located remotely from other company offices and buildings, as known in the art. Indeed, it is known for call centers associated with a company to be located in a different country from other company facilities. Furthermore, many call centers are operated by a first company under a contract with a second company to answer calls on behalf of the second company (e.g., calls from the second company's customers). The present invention is applicable to both such outsourced call centers and company-owned call centers.

Note that the term “employee” is used broadly herein for purposes of convenience, and is intended to include within its scope of meaning not only those personnel who would be considered employees in a legalistic sense of the term, but any personnel who perform the above-described call center work, including those working on a contract basis, volunteer basis, or any other basis. Similarly, although the term “management” is used herein for convenience to distinguish the personnel of the organization who are charged with monitoring and evaluating the performance of those who perform the above-described call center work, it should be noted such “management” personnel may themselves be employees of the organization in a legalistic sense, or they may be owners, partners, principals, contractors, or otherwise associated with the organization or a body overseeing the organization. In instances in which the call center is outsourced, i.e., operated by a first company under a contract with a second company, to answer calls on behalf of the second company, the “management” referred to herein can include the management of both the first and second companies.

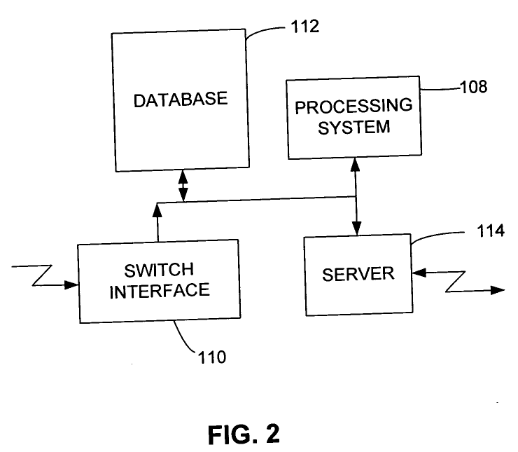

Call center 100 also includes an employee monitoring system 106, shown in further detail in FIG. 2. As illustrated in FIG. 2, employee monitoring system 106 includes a suitable processing system 108, which may comprise computer processors, associated memory and supporting hardware and software (not shown for purposes of clarity) for effecting the methods described below. Employee monitoring system 106 further includes a conventional switch interface 110, which monitors the calls that are routed by telephony equipment 102 to stations 104 and gathers information relating to the calls, such as their lengths, the employees to whom they are routed, and the calling numbers, in the conventional manner. Under control of processing system 108, such information is stored in a database 112. Conventionally, such information has been used to evaluate the performance of employees at stations 104 under certain performance criteria or metrics. For example, one performance criterion that has been used in the art to evaluate the performance of employees is the average call handle time (AHT), which is the amount of time that an employee spends, on average, on each call. The manner in which a computer can retrieve the length of each call from telephony equipment 102 and calculate an average call time for each employee is well-known and therefore not described herein in further detail for purposes of clarity. The manner in which the information needed to calculate other such well-known performance criteria are retrieved from telephony equipment 102 and used is similarly well-known and therefore not described in detail herein. The employee monitoring system 106 of the present invention further includes a server 114 or similar device that enables managers or others to operate the system, query database 112 and obtain reports, as described in further detail below. As indicated in FIG. 1, such persons can use terminals 116 located either near employee monitoring system 106 or remotely, e.g., via the Internet or other communication network 117. Similarly, the above-described elements of the exemplary employee monitoring system 106 can be co-located or, alternatively, distributed among several geographic locations via a suitable network.

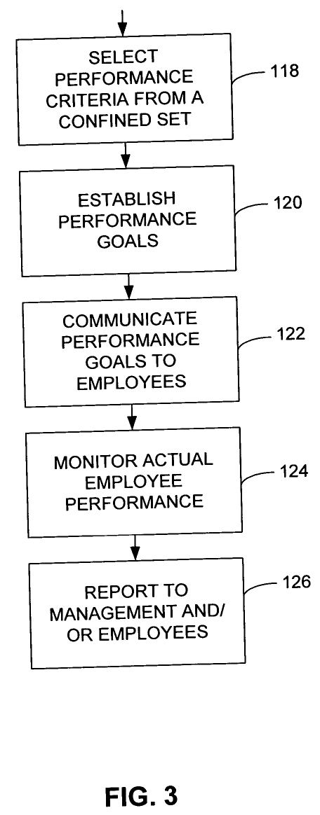

The generalized steps of an exemplary method for managing employee performance are illustrated in FIG. 3. These steps can be effected by processing system 108 (FIG. 2) under control of suitable software. As described in further detail below, the software may in part take the form of a tool having a graphical user interface (GUI).

At step 118, performance criteria to be used in evaluating the performance of the call center employees are selected or identified. Preferably, this step is performed prior to the other steps, such as at the time the software is written or at the time it is installed and configured in processor system 106. In other words, the criteria are preferably predetermined or pre-established in advance of use of the system by management. For example, the performance criteria can be hard-coded in the software, or they can be coded in a manner that allows software maintenance personnel or supervisory personnel to select the criteria or change the selected criteria from time to time. The purpose of predetermining or pre-selecting a controlled number of performance criteria rather than allowing a manager to freely select from among potentially dozens of different performance criteria is to focus the manager's attention upon the number and type of performance criteria which, in accordance with the present invention, have been found to provide the best results, as described in further detail below.

Between three and seven of the numerous possible performance criteria (also referred to in the art as “metrics”) are selected. It has been discovered in accordance with the present invention that limiting or confining the number of performance criteria to a range of three to seven produces surprisingly improved results over using more than seven or fewer than three. More specifically, it has been discovered that monitoring fewer than about three performance criteria does not provide a sufficiently clear measure of performance to management and does not provide a sufficient barrier to employees attempting to circumvent the performance monitoring system. As discussed above, as an example of how a system using too few criteria could be abused by employees, if the goal were to have a seven minute average call handle time, a worker could potentially improve his or her apparent performance by disconnecting a first caller almost immediately and then placing a second caller on hold for fourteen minutes before transferring the second caller to someone else. By using three to seven performance criteria, it is less likely that an employee will be capable of manipulating all of them in such an unscrupulous manner, particularly if the criteria are selected to be complementary or synergistic. Conversely, it has been discovered that monitoring more than about seven performance criteria provides an excessive quantity of information to management, who find it difficult to distill from so much information a clear understanding of how well an employee is actually performing and to compare the employee's performance with that of other employees. Similarly, employees who wish to improve their performance through proper means may find it difficult to focus upon the areas in which they need improvement. Providing management with reports based upon no less than about three and no more than about seven criteria allows management to quickly and easily gain an understanding of how well an employee is performing, compare the performance of one employee with the performance of others, and compare the performance of an entire call center team or other such organization with the performance of similar organizations and with its own past performance.

It is believed that at least several dozen and perhaps as many as one-hundred different performance criteria or metrics for evaluating call center employees have been identified by practitioners in the art to which the invention relates, and some commercially available systems for monitoring call center employee performance allow managers to query the system regarding any of these criteria in which the manager may be interested. Because they are numerous and well-known to persons skilled in the art, all such possible performance criteria are not listed and described exhaustively herein. The term “numerous possible performance criteria” as used herein is intended to refer to the set of call center employee performance criteria that includes those criteria described below plus all those that are well-known in the art.

It has been found that, of the numerous possible performance criteria, selecting at least two (but most preferably, four to six) of the following six performance criteria for inclusion in the set of selected criteria provides surprisingly improved results due to their synergy: quantity of call transfers; quantity of short duration calls; employee availability to receive calls; average call handle time (AHT); frequency of repeat calls; and a subjective quality score. The last two, frequency of repeat calls and subjective quality, are also believed to complement each of the others because they can be considered measures of employee effectiveness while the others can be considered measures of employee productivity (efficiency). It has been found that including at least one criterion relating to employee productivity (efficiency) and one criterion relating to employee effectiveness in the set of selected criteria provides excellent results because the effectiveness criterion can reveal instances of an employee attempting to artificially improve productivity at the expense of effectiveness or quality. Other measures of employee effectiveness will occur readily to persons skilled in the art.

Call transfers refers to the act of an employee transferring a call to another station 14 so that the other employee can handle the call. A conference call, in which an employee gets another employee on the line simultaneously, is also considered a type of transfer. The quantity of an employee's call transfers is useful for a manager to know because an employee who transfers too many calls is simply shifting work to other employees that the employee should be doing himself or herself. Employees should minimize the number of call transfers if they are to be considered good performers.

Short calls are those that have a length in second less than a predetermined threshold that is short in relation to the expected average call handle time. For example, if management determines that the target or goal average call handle time should be about seven minutes, calls less than one minute might be considered short. In any event, the meaning of “short calls” in relation to the target average call time is well-understood in the art. The number of an employee's short calls is useful for a manager to know because a high number of short calls indicates the employee may not be thoroughly addressing the callers' issues or may be abusing callers by hanging up on them. Employees should minimize the number of short duration calls if they are to be considered to be good performers.

Employee availability refers to the time the employee spends on matters other than handling calls when the employee could be handling calls. Employee availability is useful for a manager to know because an employee who is unavailable for too great a percentage of the time spent at his or her station 104 may not be working diligently or may be spending too much time on other tasks. Employees should maximize their availability if they are to be considered to be good performers.

Frequency of repeat calls refers to how many times a caller calls back after a first call. A repeat call may occur if, for example, the employee did not adequately address the caller's problem the first time or if the caller is experiencing multiple problems. Employees should minimize the frequency of repeat calls they receive if they are to be considered to be good performers. The period of time over which the repeating can be tracked is variable.

The Subjective Quality Score represents how well an employee is perceived by a supervisor or other persons charged with monitoring the employee's calls to perform in each of a number of subjective categories, such as: whether the employee properly greeted the caller; whether the employee's tone and demeanor were proper for the caller; whether the employee resolved the caller's issue; whether the information the employee gave the caller was accurate; and whether the employee left the caller with appropriate expectations. Persons skilled in the art will recognize still other suitable subjective quality criteria. The person monitoring the employee enters a score (for example, a percentage, with 100% being a perfect score) for each category each time the person monitors one of that employee's calls. The Subjective Quality Score (SQS) can be, for example, the average of an employee's scores in all of the categories over a predetermined period of time. For example, an employee may have six calls monitored during a one-week period. The employee's SQS would be the average of the employee's scores in each category over the six calls over the one-week period.

Average call handle time (AHT) is a useful criterion of employee performance because it can indicate whether the employee is devoting (on average) either too much or too little time to the caller. Ideally, the employee should adequately address each caller's issues without wasting any time unnecessarily with the caller. Average call time by itself is a relatively poor performance criterion because, as explained above, employees can relatively easily manipulate their average call times by, for example, hanging up on some callers and transferring other callers after having placed them on hold. Thus, this criterion has been found to be much more useful in conjunction with some of the other criteria listed herein, such as the quantity of call transfers and the quantity short duration calls, and particularly in conjunction with an employee effectiveness criterion such as frequency of repeat calls. If the selected set of performance criteria includes at least two (but more preferably four to six) of the criteria detailed herein, the results have been found to provide a much more accurate and easily understood picture of employee performance than the results of prior methods. Note that the set of six above-listed criteria is not exhaustive of the criteria that may be selected at step 118, but this set has been found to be especially beneficial for the reasons discussed above.

At step 120, a performance goal for each of the selected performance criteria is established. This value represents the goal or target that each employee should aspire to achieve to be considered by management to be a good performer. Step 120 can be performed more or less concurrently with step 118 or it can be performed at a later time. For example, management can change the performance goals from time to time as more employees reach the previous goals. In this manner, employees are continually urged to perform better.

At step 122, the performance goals are communicated to the call center employees. By knowing the goals that management would like the employees to reach, employees can strive to attain those goals. The goals can be communicated at any suitable time and in any suitable manner, such as by providing a printed report for each employee or group of employees or by making the report available in electronic format at stations 14.

At step 124, the actual performance of the call center employees in relation to the performance goals is monitored. As described above, employee monitoring system 106 can gather from telephony equipment 102 the call data upon which such actual performance is based in the conventional manner, and calculate or otherwise provide the actual performance in response to the gathered call data. For example, the actual performance of a call center employee in relation to the performance goal of having an average call time of seven minutes can be monitored by obtaining the duration of each call handled by that employee, calculating the average, and comparing the average with the established performance goal of seven minutes. Employees should have an AHT within a predetermined range surrounding the goal, or alternatively, an AHT less than a predetermined maximum, if they are to be considered good performers.

At step 126, the actual performance of the call center employees in relation to the performance goals is reported. In some embodiments of the invention, the actual performance is reported to the call center employees themselves. Alternatively, in other embodiments, the actual performance is reported to management. In still other embodiments, it is reported to both employees and management. As described below in further detail with regard to an exemplary software tool, the reports can be in electronic or printed form and can show the actual performance in relation to the performance goals by, for example, showing actual performance in one column of the report and the corresponding performance goal in another column. Reports can be prepared that show actual performance in relation to the performance goals for each individual employee, the totals for a group of employees collectively, or the totals across an entire organization (e.g., the totals of several groups of employees). In addition, the performance of managers can be evaluated by measuring the collective performance of the employees whom they supervise or whom are below them in the organization's management hierarchy. For example, the performance of a call center supervisor is reflected in a report showing the collective performance of the employees (i.e., the agents manning the telephones) whom he or she supervises. Likewise, the performance of one who manages an entire call center is reflected in a report showing the collective performance of the employees of the supervisors who report to that manager. The performance of an area manager or regional vice president, higher up in the hierarchy, can likewise be reflected in reports showing the collective performance of the employees beneath them in the hierarchy. Special reports can be provided showing the actual performance in relation to the performance goals for only a predetermined number of employees who perform worse than the remaining employees or, alternatively, a predetermined number of employees who perform better than the remaining employees. For example, as described below in further detail, a report can show the performance of the 25 most under-performing employees or, alternatively, in other embodiments of the invention, the 25 top-performing employees, or in still other embodiments, both the 25 most under-performing employees and 25 top-performing employees.

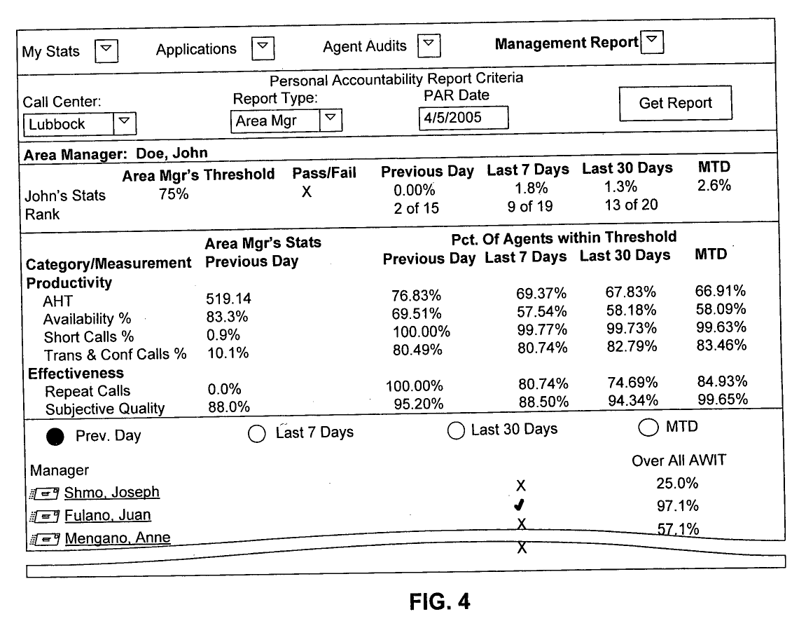

Processing system 108 can be programmed with suitable software to provide a graphical user interface (GUI) that facilitates the above-described reporting step 126. The GUI comprises a number of screens through which the user can navigate by activating interactive display elements such as hyperlinks, checkboxes, pull-down menus, etc., using a mouse or similar means (not shown) in the conventional manner. The screens depicted in FIGS. 4-10 relate to an example of a user navigating in this manner. Also, in the illustrated example, six performance criteria are pre-selected (e.g., by hard-coding them in the software): average call handle time (AHT), employee availability, short calls, transfer and conference calls, frequency of repeat calls, and subjective quality. Performance goals for each of the criteria are similarly pre-established. To generate one of the reports described below, processing system 108 (FIG. 2), under software control, issues pre-defined (e.g., hard-coded) SQL queries to database 112 (FIG. 2), processes the information as needed to provide averages or other computed values that may be required for the report, compiles the retrieved information into the predefined report format, and causes the generated screen to be transmitted to and displayed on the user's terminal or other device in real-time or near real-time. Persons skilled in the art to which the invention relates will readily be capable of creating or otherwise providing suitable software in view of the teachings herein.

As illustrated in FIG. 4, the GUI screen has a top-level menu that enables a manager to select from four categories of options, labeled “My Stats,” “Applications,” “Agent Audits” and “Management Report.” Each category has a pull-down menu associated with it that provides a number of options (not shown) associated with that category. Other top-level menu options typically associated with software tools, such as one through which a user can request help, and others through which the user can log in, log out, and perform administrative functions or functions not directly related to the present invention, can also be included but are not illustrated for purposes of clarity.

The GUI screen depicted in FIG. 4 is provided in response to the user selecting the pull-down menu option of “Personal Accountability Report” (PAR) under the “Management Report” category, selecting a Call Center and Report Type, and clicking on a “Get Report” button. A PAR is a report that shows the actual performance of a call center employee, group of employees, call center as a whole, or group of call centers, in relation to performance goals. In this example, the user has selected a call center referred to as “Lubbock” and a Report Type of “Area Mgr,” indicating the user wishes to review the performance of the area manager of the Lubbock call center. As noted above, in the context of the present invention the performance of a manager is measured by the performance of the employees beneath the manager in the hierarchy. In this example, actual performance in relation to performance goals is reported by indicating the percentage of agents (working in the Lubbock call center under the call center's area manager) who were within the predetermined threshold, i.e., who met their performance goals, rather than by listing the performance goals themselves for each of the six performance criteria. The report relates to employee performance on the previous day, as indicated by the selection of a “Prev. Day” checkbox. A similar report can be generated for the last seven days, last 30 days, or month-to-date (“MTD”) by selecting the corresponding checkbox. Note that performance over the last seven days, last 30 days and month-to-date is shown in relation to the previous day's performance to facilitate evaluating how the group's most recent performance compares with the group's past performance.

The report also indicates whether the area manager “passed” or “failed.” If fewer than a predetermined percentage (e.g., 75% in the illustrated example) of the employees under that area manager met all of their performance goals, the manager is considered to have failed, as indicated by “X” in this example. A checkmark would be used in place of the “X” to indicate a pass. The report also indicates the manager's rank in comparison with other area managers, as measured by the percentage of the manager's employees who met all of their performance goals. Note that the report also lists managers who report to that area manager, and indicates whether each of those managers passed or failed by a checkmark or “X” and each manager's agents-within-threshold (AWIT) percentage. The AWIT is the percentage of employees (i.e., lower level managers) reporting to that area manager whose employees (i.e., the customer service agents handing the telephones) met all of their performance criteria. An additional convenient feature allows the user to send an e-mail message to any of the listed managers, as indicated by a letter-like icon adjacent the manager's name that the user can click on to select.

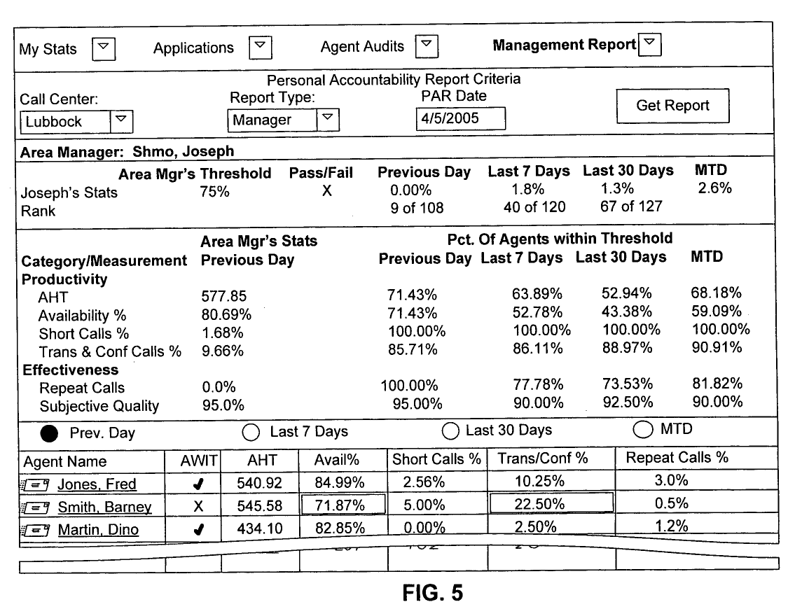

Note that each manager's name is underlined in the manner of a hyperlink to indicate that it can be selected by clicking on it. Selecting a manager name causes a similar PAR relating to that manager to be generated. The GUI screen depicted in FIG. 5 is generated in response to the user selecting one of the manager names displayed on the screen of FIG. 4. Note that that PAR in turn lists the agents who report to the selected manager and that each agent's name is underlined to indicate that it can be selected in the manner of a hyperlink. A user can then select one of those agents to cause a PAR relating to that agent to be generated. This use of hierarchical menus (or “drill-down” menus in the lexicon of user interfaces) allows a user to quickly and easily evaluate and compare the performance of employees in the organization's hierarchy and across groups within the organization.

The portion of the PAR indicating the agents' actual performance in relation to performance goals is configured as a table in this example, with the agents' names listed in rows and the six performance criteria listed in columns. The percentage of calls handled by each agent in which the agent met the performance goal is listed within the table. In the case of average call handle time (AHT), the agent's AHT is listed in seconds. Any percentage (or AHT) that is not within a corresponding predetermined threshold, i.e., that does not meet the corresponding performance goal, is highlighted, as indicated by a box around the percentage. An additional column lists whether the agent performed within threshold (AWIT), i.e., met the performance goal, for each of the criteria. If an agent met the performance goal for all of the criteria, a checkmark appears in the AWIT column. Otherwise, an “X” appears in that column.

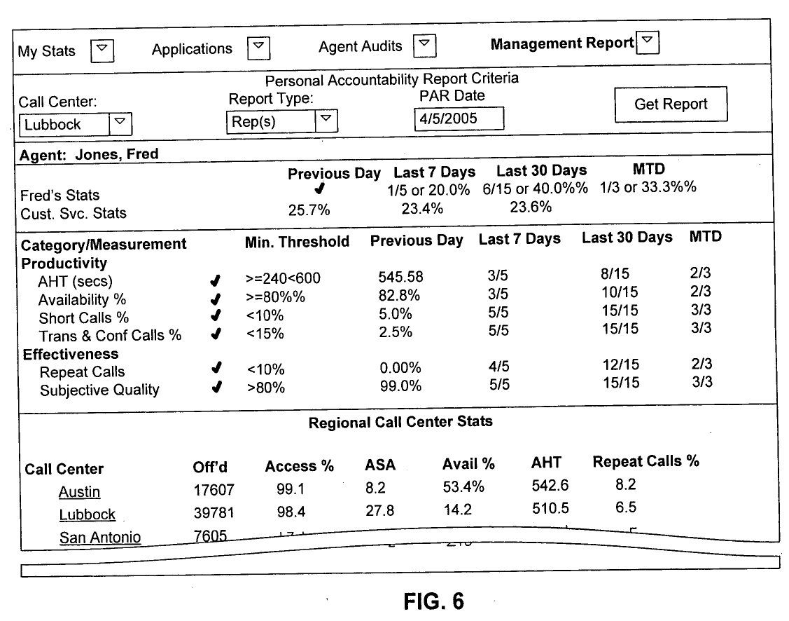

The GUI screen depicted in FIG. 6 is provided in response to the user selecting one of the agent names displayed on the screen of FIG. 5. The PAR indicates the threshold or performance goal and the agent's actual performance for each of the six performance criteria. The report also indicates with a checkmark or “X” whether the agent passed or failed in each of the six performance criteria. The report further includes information to allow the user to compare the agent's performance with other agents in the same call center and with other agents in other call centers in the same geographic region.

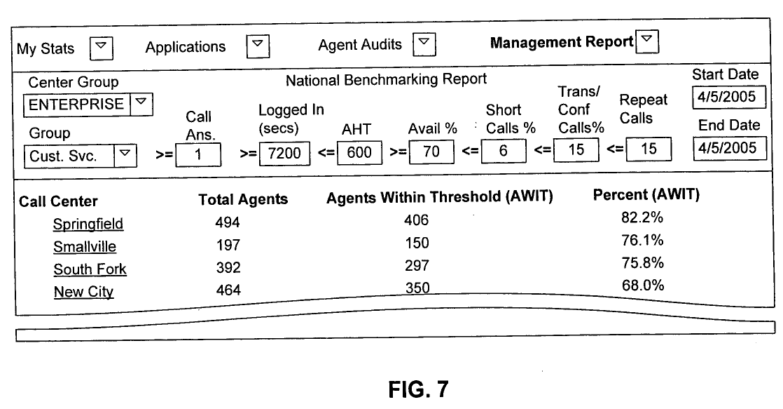

The GUI screen depicted in FIG. 7 is provided in response to the user selecting the pull-down menu option of “National Benchmarking Report” under the “Management Report” category, selecting a Call Center Group and sub-group, filling in various filter values for the six criteria plus a date range plus the number of calls answered (“Call Ans.”) and number of seconds the employee remained logged in. The resulting report lists each of the call centers along with the total number of agents working at each, the number (and, equivalently, percentage) of those agents whose performance was within threshold (AWIT). In this case, the thresholds are not the pre-established values (FIG. 2, step 120) but rather as indicated by filter values the user fills in on this screen.

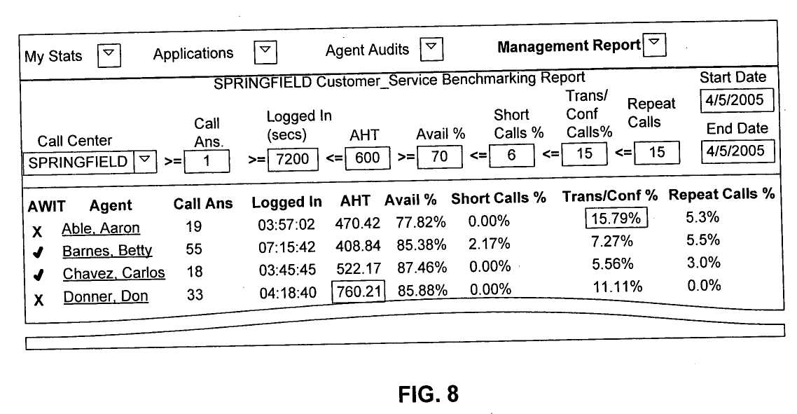

The GUI screen depicted in FIG. 8 is provided in response to the user selecting the pull-down menu option of “Customer Service Benchmarking Report” under the “Management Report” category, selecting one of the calls centers, filling in various filter values for the six criteria, a date range, the number of calls answered (“Call Ans.”) and number of seconds the employee remained logged in. (“Customer Service,” referring to those call centers specifically tasked with handling customer service-related issues of the type described above, can be just one of several call center sub-groups that can be selected. Another example of a call center sub-group is Collections, referring to those call centers tasked with handling the collection of payments owed by customers.) The resulting report lists each of the agents working at the selected call center, the number of calls they answered, the amount of time they remained logged in, and their actual performance for each of the six (customer service-related) criteria. Performance values not meeting the performance thresholds or goals are highlighted with a box around them, and an “X” rather than a checkmark appears in the AWIT column. Again, the thresholds are not the pre-established values (FIG. 2, step 120), but rather are indicated by filter values the user fills in on this screen. Other types of information typically included in reports relating to employees can also be included in this report, such as employee numbers and the names of the employees' supervisors, but are not shown for purposes of clarity.

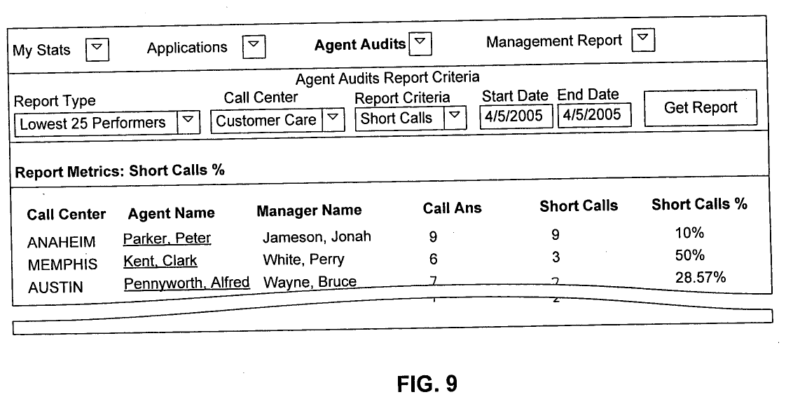

The GUI screen depicted in FIG. 9 is provided in response to the user selecting the pull-down menu option of “Agent Audits Report Criteria” under the “Agent Audits” category, selecting a Report Type, Call Center type or sub-group, Report Criteria, and a date range. The Report Criteria that can be selected can be any one of the six, or “All” can be selected. In this example, the user has selected a Report Type of “Lowest 25 Performers,” a Call Center type of “Customer Care,” and Report Criteria of “Short Calls.” The resulting report lists the names of the 25 lowest-performing agents, the call centers at which they work, the names of their managers, the total number of calls they answered, the number of short calls, and short calls stated as a percentage of total calls.

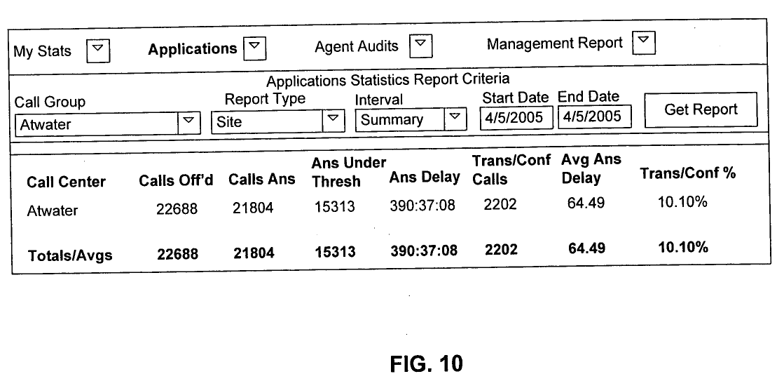

The GUI screen depicted in FIG. 10 is provided in response to the user selecting the pull-down menu option of “Applications Statistics Report Criteria” under the “Applications” category, selecting a Call Group, Report Type, Interval, and date range. The resulting report provides information relating to the overall performance of the selected call center: the names of the call center(s) of the selected group, the total number of incoming calls, the total number of calls answered, the number of calls answered within a predetermined threshold number of seconds, the total or aggregate delay in seconds for all calls to be answered, the number of transferred calls, the average number of seconds for a call to be answered, and the transferred calls stated as a percentage.

In the above-described embodiment of the invention, five call center employee performance criteria are monitored and used to generate various types of reports that relate actual employee performance to employee performance goals. The reports can be of a drill-down or hierarchical type, in which the performance of a manager can be evaluated based upon the performance of the manager's employees, and a report can be requested for the performance of an employee by selecting the employee name on the report for the employee's manager. In a similar manner, the reports allow management to compare actual performance of a group or other organization (e.g., a call center, group of call centers, or group of employees within a call center) against performance goals, compare the actual performance of the group against that of other such groups, and compare the actual performance of a group against its own past performance.

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A method for managing employee performance in a call center environment, the method comprising the steps of:
selecting no fewer than three and no more than seven performance criteria from among numerous possible performance criteria for call center employees;
establishing a performance goal for each of the selected performance criteria;
communicating the performance goals to the call center employees;
monitoring actual performance of the call center employees in relation to the performance goals; and
reporting to recipients selected from a group of recipients consisting of management and the call center employees the actual performance of the call center employees in relation to the performance goals.

2. The method as claimed in claim 1, wherein the selecting step comprises selecting at least one performance criterion reflecting employee productivity and at least one performance criterion reflecting employee effectiveness.

3. The method as claimed in claim 1, wherein the selecting step comprises selecting no fewer than four and no more than six performance criteria.

4. The method as claimed in claim 3, wherein one of the selected performance criteria is quantity of call transfers.

5. The method as claimed in claim 3, wherein one of the selected performance criteria is quantity of short duration calls.

6. The method is claimed in claim 3, wherein one of the selected performance criteria is employee availability to receive calls.

7. The method as claimed in claim 3, wherein one of the selected performance criteria is average call handle time.

8. The method as claimed in claim 3, wherein at least two of the performance criteria are selected from the group consisting of: quantity of call transfers, quantity of short duration calls, employee availability to receive calls, average call handle time, frequency of repeat calls, and a subjective quality score.

9. The method as claimed in claim 3, wherein the performance criteria comprise:
quantity of call transfers;
quantity of short duration calls;
employee availability to receive calls; and
average call handle time.

10. The method as claimed in claim 1, wherein one of the selected performance criteria is selected from the group consisting of: frequency of repeat calls, and a subjective quality score.

11. The method as claimed in claim 1, wherein the reporting step comprises providing predefined reports accessible in substantially real time at a computer terminal.

12. The method claimed in claim 11, wherein the predefined reports are configured to allow management to view actual performance of a first organization in relation to the performance goals, to compare the actual performance of a first organization against other organizations, and to compare the actual performance of the first organization against past performance of the first organization.

13. The method as claimed in claim 12, wherein the predefined reports are configured to allow management to view actual performance across an entire organization and selectably view actual performance of sub-groups of the organization.

14. The method claimed in claim 11, wherein the predefined reports include a report relating to actual performance of each of a predetermined number of poorest-performing call center employees.

15. A system for managing employee performance in a call center environment, comprising a processor system in communication with call center telephony equipment and programmed or adapted to:
monitor, in response to employee call data received from the call center telephony equipment, actual performance of call center employees in relation to call center employee performance goals pre-established for each of no fewer than three and no more than seven performance criteria pre-selected from among numerous possible performance criteria; and
report to recipients selected from a group of recipients consisting of management and the call center employees the actual performance of the call center employees in relation to the performance goals.

16. The system as claimed in claim 15, wherein the processor system is programmed or adapted to monitor actual performance of call center employees for each of no fewer than four and no more than six performance criteria pre-selected from among numerous possible performance criteria.

17. The system as claimed in claim 15, wherein at least two of the performance criteria are selected from the group consisting of: quantity of call transfers, quantity of short duration calls, employee availability to receive calls, average call handle time, frequency of repeat calls, and a subjective quality score.

18. The system as claimed in claim 15, wherein the pre-selected performance criteria comprise:
quantity of call transfers;
quantity of short duration calls;
employee availability to receive calls; and
average call handle time.

19. The system as claimed in claim 15, wherein one of the selected performance criteria is selected from the group consisting of: frequency of repeat calls, and a subjective quality score.

20. The system as claimed in claim 15, wherein the processor system is programmed or adapted to provide predefined reports accessible in substantially real time at a computer terminal.

21. The system as claimed in claim 20, wherein the processor system is programmed or adapted to provide a database having pre-established queries relating to the actual performance of the call center employees.

22. The system claimed in claim 21, wherein the queries comprise: actual performance of a first organization in relation to the performance goals, actual performance of a first organization against other organizations, and actual performance of the first organization against past performance of the first organization.
